(19) United States
(12) Patent Application Publication
(10) Pub. No.: US 2019/0381721 A1
(43) Pub. Date: Dec. 19, 2019

(54) TOOL FOR FIXING A TEXTILE SLEEVE ABOUT AN ELONGATE MEMBER AND METHOD OF FIXING A TEXTILE SLEEVE ABOUT AN ELONGATE MEMBER

(71) Applicant: FEDERAL-MOGUL POWERTRAIN LLC, Southfield, MI (US)

(72) Inventors: Hiroki Yamaguchi, Kanagawa (JP); Shozo Fukuyama, Tokyo (JP)

(21) Appl. No.: 16/443,395

(22) Filed: Jun. 17, 2019

Related U.S. Application Data
(60) Provisional application No. 62/686,572, filed on Jun. 18, 2018.

(51) Int. Cl. B29C 63/06; B29C 63/00; H01B 13/26

(52) U.S. Cl. CPC B29C 63/06; B29C 63/0073; B65H 81/06; H01B 13/268; B29C 63/0017; B29C 63/0069

(57) ABSTRACT

A tool and method for fixing a textile sleeve about an elongate member is provided. The tool includes at least one clamp assembly having opposed heating clamp members movable between open and closed states and opposed cooling clamp members movable between open and closed states. Each of the heating and cooling clamp members have respective heating and cooling clamp surfaces configured for clamping abutment with the textile sleeve. The heating clamp surfaces are operably connected to a source of power to be selectively heated and the cooling clamp surfaces are operably connected to a source of coolant to be selectively cooled. A carrier is configured to support the textile sleeve for movement from a loading position to a location between the heating clamp members; from the heating clamp members to a position between the cooling clamp members, and from the position between the cooling clamp members to an unloading position.

### CROSS-REFERENCE TO RELATED APPLICATION

This application claims the benefit of U.S. Provisional Application Ser. No. 62/686,572, filed Jun. 18, 2018, which is incorporated herein by reference in its entirety.

### BACKGROUND OF THE INVENTION

### 1. Technical Field

This invention relates generally to protective textile sleeves for providing protection to elongate members contained therein, and more particularly to a tool for fixing a protective textile sleeve about an elongate member extending therethrough.

### 2. Related Art

Protective textile sleeves for providing protection to elongate members extending therethrough are known. Typically, the protective sleeves are formed having one of a tubular wall having a circumferentially continuous wall, or a wrappable wall having opposite lengthwise extending edges configured to be wrapped into overlapping relation with one another. Depending on the type of aforementioned wall and end use, a portion of the sleeve can be fixed to itself to be maintained enclosed about the elongate member or to the elongate member extending therethrough via separately applied wrapped tape or glue applied during installation. The use of tape to secure the sleeve in place has various drawbacks, as it is costly from a material and labor standpoint, and it can also prove unsightly if not applied correctly. Further, the externally applied tape must be readily available during installation of the sleeve, otherwise the assembly process can be delayed, and further yet, the tape can become inadvertently damaged or ineffectively applied during assembly, such as by being inadvertently folded on itself or contaminated via dirty surroundings or hands during application, thereby adversely affecting the ability of the tape to reliably fix the sleeve about the elongate member as intended. The application of separately applied glue during assembly is also costly from a material and labor standpoint, and further requires being readily available during assembly of the sleeve, and can further add cost as a result of the need to provide drying time for the glue. In addition, glue lacks strength at elevated temperatures, and can prove messy in application, thereby leading to further cost associated with damage, repair and the necessary clean-up thereof. In addition to the aforementioned drawbacks, both known mechanisms discussed above can be time consuming in process, which ultimately adds cost to the process.

### SUMMARY OF THE INVENTION

This section provides a general summary of some of the objects, advantages, aspects and features provided by the inventive concepts associated with the present disclosure. However, this section is not intended to be considered an exhaustive and comprehensive listing of all such objects, advantages, aspects and features of the present disclosure.

It is an object of the present disclosure to provide a clamping tool that overcomes disadvantages of known fixation mechanisms for attaching a sleeve to itself and/or to an elongate member extending therethrough.

It is a further object of the present disclosure to provide a method of fixing a sleeve to itself and/or to an elongate member extending therethrough that overcomes disadvantages of known methods of fixing a sleeve to itself and/or to an elongate member extending therethrough.

In accordance with these and other objects, advantages, aspects and features of the disclosure, a clamping tool for effectively and efficiently fixing a protective textile sleeve about an elongate member contained in a cavity of the sleeve is provided.

In accordance with another aspect of the disclosure, the clamping tool includes at least one clamp assembly having opposed heating clamp members movable between open and closed states and opposed cooling clamp members movable between open and closed states. Each of the heating and cooling clamp members have a clamp surface configured for clamping abutment with the textile sleeve. The heating clamp surfaces are operably connected to a source of power to be selectively heated and the cooling clamp surface are operably connected to a source of coolant medium. The clamping tool further includes a carrier configured to support the textile sleeve for movement from the heating clamp members to the cooling clamp members.

In accordance with another aspect of the disclosure, the opposed heating and cooling clamp members can be supported by a housing, with the carrier being configured for sliding movement along the housing to carry the textile sleeve from the heating clamp members to the cooling clamp members.

In accordance with another aspect of the disclosure, the opposed heating clamp members can be configured for movement along a first axis between open and closed states and the opposed cooling clamp members can be configured for movement along a second axis between open and closed states, wherein the first and second axes are parallel to one another.

In accordance with another aspect of the disclosure, the carrier can be configured for movement along a third axis to carry the textile sleeve from the heating clamp members to the cooling clamp members, wherein the third axis is generally transverse to the first and second axes.

In accordance with another aspect of the disclosure, the housing can be formed being generally U-shaped having a base and upstanding support columns spaced from one another by a slide channel sized for clearance receipt of the textile sleeve therein. Each of the opposed heating clamp members can be supported on a separate one of the support columns for movement along the first axis toward one another to the closed state and away from one another along the first axis to the open state, and each of the opposed cooling clamp members can be supported on a separate one of the support columns for movement along the second axis toward one another to the closed state and away from one another along the second axis to the open state.

In accordance with another aspect of the disclosure, the at least one clamp assembly can include a plurality of clamp assemblies spaced in mirrored, axially aligned relation with one another such that the slide channel in one of the clamp assemblies is axially aligned with the slide channel in the other of the clamp assemblies, such that the axially aligned slide channels are configured for simultaneous receipt of the textile sleeve therein.

In accordance with another aspect of the disclosure, the opposed heating and cooling clamp members can be supported by upstanding support columns spaced from one another by a slide channel sized for clearance receipt of the textile sleeve therein. Each of the opposed heating clamp members can be supported on a separate one of the support columns for movement toward one another along the first axis to their closed state and away from one another along the first axis to their open state, and wherein each of the opposed cooling clamp members can be supported on a separate one of the support columns for movement toward one another along the second axis to their closed state and away from one another along the second axis to their open state, wherein the sleeve is carried along the third axis by the carrier for selective positioning between the heating and cooling clamp members.

In accordance with another aspect of the disclosure, a method of fixing a protective textile sleeve about an elongate member is provided. The method includes providing the protective textile sleeve having an inner surface configured to bound an internal cavity; disposing the elongate member within the inner cavity; clamping a first portion of the protective textile sleeve about the elongate member with opposed heating clamp surfaces of heating clamp members and forming a bond joint between separate portions of the protective textile sleeve and/or between the protective sleeve and the elongate member by heating the first portion of the textile sleeve with the heating clamp surfaces of the heating clamp members; and clamping the first portion of the protective textile sleeve about the elongate member with opposed cooling clamp members having cooling clamp surfaces formed by cooling members and cooling the bond joint with the cooling clamp members.

In accordance with another aspect of the disclosure, the method can further include clamping a second portion of the protective textile sleeve about the elongate member, with the second portion being spaced axially from the first portion, with heating clamp members and forming a bond joint between separate portions of the protective textile sleeve and/or between the protective sleeve and the elongate member by heating the second portion of the textile sleeve with the heating clamp members, and clamping the second portion of the protective textile sleeve about the elongate member with cooling clamp members having clamp surfaces formed by cooling members and cooling the bond joint with the cooling clamp members.

In accordance with another aspect of the disclosure, the method can further include performing the clamping of the first and second portions simultaneously with one another.

In accordance with another aspect of the disclosure, the method can further include moving the opposed heating clamp members toward one another into clamping relation with the textile sleeve and away from one another out of clamping relation from the textile sleeve along a first axis and moving the opposed cooling clamp members toward one another into clamping relation with the textile sleeve and away from one another out of clamping relation from the textile sleeve along a second axis, wherein the first and second axes are parallel with one another.

In accordance with another aspect of the disclosure, the method can further include moving the textile sleeve along a third axis with a carrier from a loading position to a heating position between the heating clamp members, and then moving the textile sleeve along the third axis from the heating position to a cooling position between the cooling clamp members, and then moving the textile sleeve along the third axis from the cooling position to an unloading position, wherein the third axis extends generally transversely to the first and second axes.

In accordance with another aspect of the disclosure, the method can further include moving the textile sleeve with elongate member therein from the heating clamp members to the cooling clamp members within about 1-5 seconds after forming the bond joint.

In accordance with another aspect of the disclosure, the method can further include completing the heating of the first portion of the textile sleeve with the heating clamp members within about 4-10 seconds.

In accordance with another aspect of the disclosure, the method can further include heating the first portion of the textile sleeve with the heating clamp members at a temperature between about 190-230 degrees.

In accordance with another aspect of the disclosure, the method can further include cooling the bond joint for about 1-6 seconds.

In accordance with another aspect of the disclosure, the method can further include cooling the first portion of the textile sleeve with the cooling clamp members at a temperature between about 60-80 degrees.

In accordance with another aspect of the disclosure, the clamping tool can be suitably sized for use on a table or desk top work station.

In accordance with another aspect of the disclosure, the clamping tool can be suitably sized for portable use.

### BRIEF DESCRIPTION OF THE DRAWINGS

These and other aspects, features and advantages of the present disclosure will become more readily appreciated when considered in connection with the following detailed description of presently preferred embodiments and best mode, appended claims and accompanying drawings, in which:

FIG. 1 is a perspective view of a wrappable protective sleeve shown fixed about an elongate member by a clamping tool constructed in accordance with one aspect of the disclosure;

FIG. 1A is a perspective view of a circumferentially continuous, seamless protective sleeve shown fixed about an elongate member by a clamping tool constructed in accordance with another aspect of the disclosure;

FIG. 2A is perspective view of a clamping tool constructed in accordance with one aspect of the disclosure for fixing a protective textile sleeve about the elongate member to be protected, shown with the protective textile sleeve in an idle position;

FIG. 2B is an end view of the clamping tool shown in FIG. 2A;

FIG. 3A a view similar to FIG. 2A with the protective textile sleeve in an idle position;

FIG. 3B a view similar to FIG. 3A with the protective textile sleeve in a heating position;

FIG. 3C a view similar to FIG. 3A with the protective textile sleeve in a cooling position; and

FIGS. 4A-4E illustrate a sequence of operations performed with the clamping tool of FIG. 2A to fix a protective sleeve about an elongate member to be protected therein.

### DETAILED DESCRIPTION OF PRESENTLY PREFERRED EMBODIMENTS

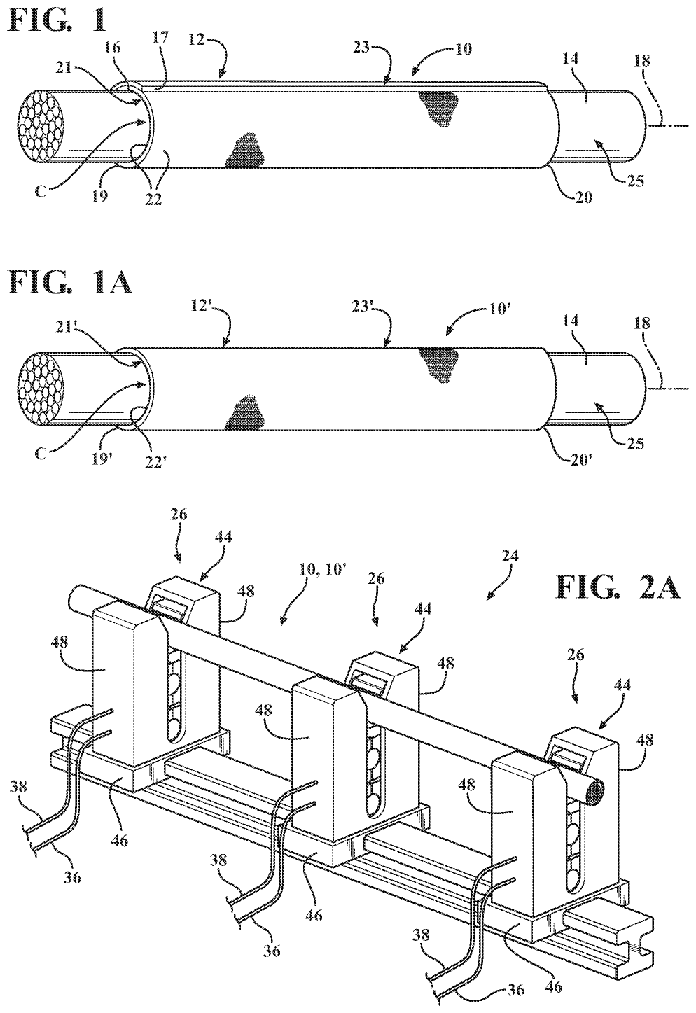

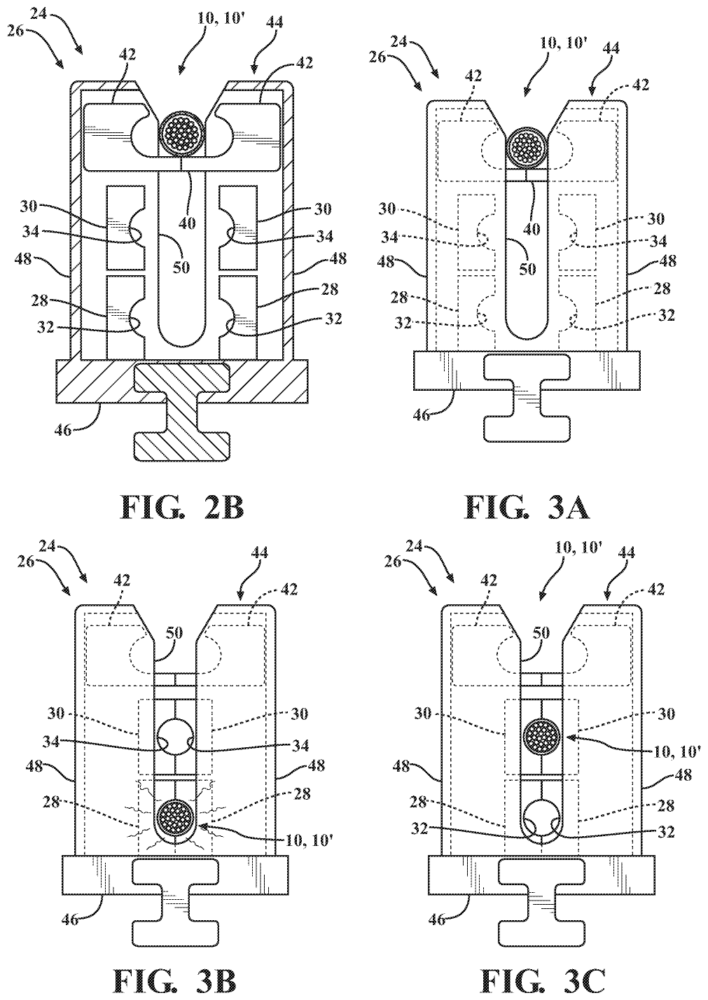

Referring in more detail to the drawings, FIGS. 1 and 1A illustrate textile sleeve assemblies constructed in accordance with one aspect of the disclosure, shown as including a wrappable sleeve 10 in FIG. 1 and as including a circumferentially continuous, seamless sleeve 10′ in FIG. 1A, and referred to hereafter commonly as sleeve, unless noted otherwise. The reference numerals used to identify the features of the sleeves 10, 10′ are the same, with the exception that the reference numerals of the sleeve 10′ are primed (′) to distinguish between the different embodiments. The sleeve 10 has a wrappable wall 12, such as a wrappable or self-wrapping elongate wall that automatically curls into its wrapped configuration absent some externally applied force, while the sleeve 10′ has a circumferentially continuous, seamless wall 12′, both for routing and protecting elongate members 14 of the textile sleeve assemblies, such as a cable, wire harness, or tube, by way of example and without limitation. The elongate wrappable wall 12 has opposite inner and outer free edges 16, 17 extending generally parallel to a central longitudinal axis 18 between opposite open ends 19, 20, wherein the edges 16, 17 can be manually wrapped or self-biased into overlapping relation with one another in “cigarette wrapped” fashion to fully enclose the elongate member(s) 14 within a central cavity C of the sleeve 10. The walls 12, 12′ have an innermost face or surface, also referred to as inner surface 21, 21′ and an outermost face or surface, also referred to as outer surface 23, 23′, wherein the cavity C is circumferentially bounded by the innermost surface 21, 21′. With the wrappable sleeve 10, the cavity C is readily accessible along the full length of the longitudinal axis 18 by selectively separating the edges 16, 17 away from one another so that the elongate member(s) 14 can be readily disposed radially into the cavity C, and conversely, removed from the cavity C, such as during service. To facilitate adhering and fixing the wall 12 to itself to maintain the wall 12 in its closed, wrapped configuration and/or to the elongate member 14 to prevent relative movement between the wall 12, 12′ and the elongate member 14, and further, to facilitate preventing end fray of the opposite ends 19, 19′, 20, 20′, such as during cold cutting in manufacture and also during in use, the wall 12, 12′ can be provide having an adhesive material, such as an adhesive coating layer, by way of example and without limitation, referred to hereafter as adhesive coating 22, 22′, bonded to at least a portion of at least one of the innermost surface 21, 21′ and/or the outermost surface 23, 23′. The adhesive coating 22, 22′ can be provided as a heat activateable and/or water activateable coating having a first, dried non-adhesive state upon first being applied to the wall 12, 12′ and second, activated adhesive state, wherein the second state is activated at a chosen time and location via a clamping tool 24 (FIGS. 2A-2B; 3A-3C; 4A-4E) constructed in accordance with an aspect the invention.

Depending on the application needs, the wall 12, 12′ can be constructed having any suitable size, including length and diameter, wherein the inventive clamping tool 24 can automatically adjust to uniformly accommodate the dimensions and configuration of the sleeve 10, 10′. Further, the wall 12, 12′ can be formed of interlaced yarn using any desired interlacing process, such as braiding, weaving or knitting. If the wall 12 is formed as a self-wrapping wall, at least some of the weft-wise, circumferentially extending yarn, whether multifilament and/or monofilament, can be provided as any suitable heat-settable polymeric material, such as polyphenylene sulfide (PPS) or polyethyleneterephthalate (PET), for example. Further, if desired, at least some of the yarn can be provided as a low melt yarn, thereby being able to be melted during the fixation process to facilitate fixing the sleeve 10, 10′ to itself and/or to the elongate member 14.

If provided, the adhesive coating 22, 22′ can be applied as a low viscosity coating formulation or high viscosity coating formulation, such as via a spraying, rolling or dipping processes, by way of example and without limitation, directly on the desired area of the innermost and/or outermost surfaces 21, 21′, 23, 23′ of the sleeve 10, 10′. Of course, it should be recognized the coating 22, 22′ can be applied to the entirety of the wall 12, 12′, if desired. When relative movement between the sleeve 10, 10′ and the elongate member 14 is to be prevented, the mixture of the coating 22, 22′ is applied and bonded to at least a portion of the innermost surface 21, 21′ that abuts directly against the elongate member 14, thereby providing the ability to bond the adhesive coating 22, 22′ to an outer surface 25 of the elongate member 14 via activation by the clamping tool 24.

Upon applying, bonding, and drying the coating 22 to the desired areas of the wall 12, the wall 12 can be subsequently heat-set into a self-wrapping wall and/or wrapped about the elongate member 14. Otherwise, it should be recognized that the wall 12 can first be heat-set into a self-wrapping wall and then the wall 12 can be sprayed, dipped or otherwise coated with mixture of coating 22 in the desired areas.

It should be recognized that upon the coating 22, 22′ being applied to the wall 12, 12′, the coating 22, 22′ attains its first, non-adhesive state upon being dried, and then, when desired, including after storing in inventory and/or shipping to the desired location where the sleeve 10, 10′ is to be disposed about the elongate member 14, the coating 22, 22′ can be selectively activated in accordance with the disclosure to form a bond with the desire surface via the clamping tool 24.

Upon the sleeve 10, 10′, being clamped, heated, and cooled in a continuous process sequence, as discussed further below, the adhesive coating 22 becomes activated and at least partially melted and solidified, thereby causing the adhesive 22 to form a bond joint with the adjacent abutting surface, whether another portion of the sleeve wall 12, 12′ and/or the outer surface 25 of the elongate member 14. The entire coating activation process can take as few as about 6-10 seconds, by way of example and without limitation.

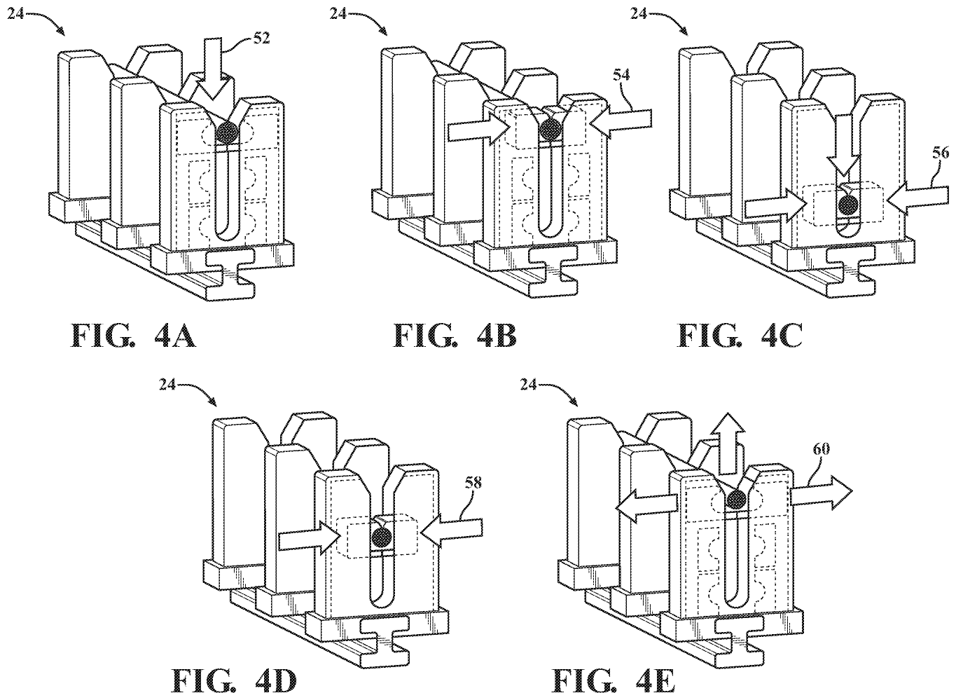

The clamping tool 24 includes at least one clamp assembly 26, and in FIGS. 2A and 4A-4E, is shown as including a plurality of clamp assemblies 26, shown as three, by way of example and without limitation. It is contemplated herein that any number of clamp assemblies 26 desired could be incorporated into the clamping tool 24. Each of the clamp assemblies 26 have opposed heating clamp members 28 movable along a first axis A1 between open (FIG. 3A) and closed (FIGS. 3B and 3C) states and opposed cooling clamp members 30 movable along a second axis A2 between open (FIG. 3A) and closed (FIGS. 3B and 3C) states. The first and second axes A1, A2 are parallel, or substantially parallel (substantially is intended to mean that the axes could be slightly less than parallel with one another, such as being a few (1-5) degrees off true parallel with one another, as will be understood by one possessing ordinary skill in the art). Each of the heating and cooling clamp members 28, 30 have respective heating and cooling clamp surfaces 32 (best shown in FIG. 3C), 34 (best shown in FIG. 3B) configured for clamping abutment with the outer surface 23, 23′ of the textile sleeve 10, 10′. The heating clamp surfaces 32 are operably connected to a source of power 36 to be selectively heated and the cooling clamp surface 34 are operably connected to a source of coolant medium, such as an air jet, by way of example and without limitation. Each of the clamp assemblies 26 of the clamping tool 24 further includes a carrier 40 configured to support and carry the textile sleeve 10, 10′ for movement along a third axis A3 from a loading/unloading position (FIG. 3A) to a heating position aligned between the heating clamp members 28 to a cooling position aligned between the cooling clamp members 30. The third axis A3 is transverse or substantially transverse to the first and second axes A1, A2 (substantially is intended to mean that the third axis A3 could be slightly off true transverse relation with the first and second axes A1, A2, such as being a few (1-5) degrees off true transverse relation, as will be understood by one possessing ordinary skill in the art). To facilitate moving and positioning the textile sleeve 10, 10′, the carrier 40 can include opposed clamp members 42 moveable along a fourth axis A4 between an open state (FIGS. 2B, 3A, 4A, 4E) to allow the textile sleeve 10, 10′ to be loaded and unloaded from the clamping tool 24 and a closed state (FIGS. 3B, 3C, 4B-4D) to allow the textile sleeve 10, 10′ to be readily transferred between the heating and cooling clamp members 28, 30. The fourth axis A4 extends parallel or substantially parallel with the first and second axes A1, A2.

The opposed heating and cooling clamp members 28, 30 of each of the clamp assemblies 26 can be supported by a housing 44. The housing 44 can be formed being generally U-shaped having a base 46 and a pair of upstanding support columns 48 spaced from one another by a slide channel 50 sized for clearance receipt of the textile sleeve 10, 10′ therein for free clearance movement of the textile sleeve 10, 10′ between the heating and cooling clamp members 28, 30. The plurality of clamp assemblies 26 are spaced in mirrored, axially aligned relation with one another (axially aligned along an axis extending generally transversely to the first, second axes A1, A2 and generally parallel to the central axis 18 of the sleeve 10, 10′) such that the channels 50 are axially aligned with one another for simultaneous receipt of the textile sleeve 10, 10′ therein. Each of the opposed heating clamp members 28 can be supported on a separate one of the support columns 48 for movement toward one another along the first axis A1 to the closed state and away from one another along the first axis A1 to the open state. Likewise, each of the opposed cooling clamp members 30 can be supported on a separate one of the support columns 48 for movement toward one another along the second axis A2 to the closed state and away from one another along the second axis A2 to the open state. The heating clamp members 28 are shown below the cooling clamp members 30, by way of example and without limitation. The carrier 40 of each clamp assembly 26 is configured for sliding movement along the columns 48 of the housing 44 to carry the textile sleeve 10, 10′ along the third axis A3 from the open, loading/unloading position to a heating location aligned between the heating clamp members 28 and then to a cooling location aligned between the cooling clamp members 30 and then back along the third axis A3 to the open, loading/unloading position.

In use, with reference to FIGS. 4A-4E, an assembly process is illustrated, wherein the elongate member 14 is first disposed with the cavity C of the respective textile sleeve 10, 10′, and as shown in FIG. 4A, the sleeve 10, 10′ and elongate member 14 are placed on a support surfaces of the carriers 40 of the plurality of clamp assemblies 26 (sleeve 10, 10′ is shown as being lowered along a generally vertical axis illustrated by arrow 52 onto the carrier 40, wherein the vertical axis 52 is generally perpendicular to the central longitudinal axis 18). Then, upon positioning the sleeve 10, 10′ on the carriers 40, as shown in FIG. 4B, the carrier clamp members 42 are actuated to move horizontally toward one another along a horizontal direction illustrated by arrow 54 and along the fourth axis A4. The clamp members 42 are brought into clamped engagement with the outer surface 23, 23′ of the textile sleeve 10, 10′ to compress the inner surface 21, 21′ into engagement with the elongate member 14. Then, as shown in FIG. 4C, the carrier 40 is actuated to lower the textile sleeve 10, 10′ through the channels 50 along the third axis A3 toward the base 46 into horizontally aligned positioning between the heating clamp members 28 of the separate clamp assemblies 26, and then, the heating clamp members 28 are actuated to move horizontally toward one another along a horizontal direction illustrated by arrow 56 and along the first axis A1. The heating clamp members 28 are brought into clamped engagement with the outer surface 23, 23′ of the textile sleeve 10, 10′ to compress the inner surface 21, 21′ into engagement with the elongate member 14. The heating clamp members 28 are heated via the power source 36 to a temperature between about 190-230 degrees and compressed against the outer surface 23, 23′ of the sleeve 10, 10′ for about 4-10 seconds, whereupon the inner surface 21, 21′ of the sleeve 10, 10′, and adhesive coating 22, 22′ thereon, if provided, is melted to form a bond joint between the inner surface 21, 21′ and the elongate member 14. Then, upon the heating clamp members 28 being moved along the first axis A1 to an open position, the carrier 40, as shown in FIG. 4D, is actuated to raise the textile sleeve 10, 10′ vertically along the third axis A3 through the channels 50 away from the base 46 into horizontally aligned positioning between the cooling clamp members 30 of the separate clamp assemblies 26 over a time lapse between about 1-2 seconds. Then, the cooling clamp members 30 are actuated to move horizontally toward one another along a horizontal direction illustrated by arrow 58 and along the second axis A2. The cooling clamp members 30 are brought into clamped engagement with the same location of the outer surface 23, 23′ of the textile sleeve 10, 10′ as heated to quickly cool the bond joints. The cooling clamp members 30 cool the bond joints via the coolant medium 38 to a temperature between about 60-80 degrees F. in a time span of about 1-6 seconds. Then, upon moving the cooling clamp members 30 along the second axis A2 to an open position, the carrier 40, as shown in FIG. 4E, is actuated to raise the textile sleeve 10, 10′ and elongate member 14 bonded thereto vertically through the channels 50 along the axis A3 away from the base 46 back to the loading/unloading position, whereupon the clamp members 42 are actuated to open away from one another along a horizontal direction illustrated by arrow 60 and along the axis A4, whereupon the sleeve 10, 10′ and elongate member 14 bonded thereto can be removed from the clamping tool 24, whereupon the process can be repeated with a new sleeve 10, 10′ and elongate member.

Many modifications and variations of the present invention are possible in light of the above teachings. It is, therefore, to be understood that the invention may be practiced otherwise than as specifically described, and that the scope of the invention is defined by the claims. It is contemplated that all features of all claims and of all embodiments can be combined with each other, so long as such combinations would not contradict one another.

What is claimed is:

1. A tool for fixing a textile sleeve about an elongate member disposed therein, comprising:
at least one clamp assembly having opposed heating clamp members movable along a first axis between open and closed states and opposed cooling clamp members movable along a second axis between open and closed states, each of said heating and cooling clamp members having a clamp surface configured for clamping abutment with the textile sleeve, said heating clamp surfaces being operably connected to a source of power to be selectively heated and said cooling clamp surface being operably connected to a source of coolant medium; and
a carrier configured to support the textile sleeve for movement along a third axis from said heating clamp members to said cooling clamp members.

2. The tool of claim 1, wherein said opposed heating and cooling clamp members are supported by a housing, said carrier being configured for sliding movement along said housing to carry the textile sleeve between said heating clamp members and said cooling clamp members.

3. The tool of claim 2, wherein said housing is generally U-shaped having a base and upstanding support columns spaced from one another by a slide channel sized for clearance receipt of the textile sleeve therein, each of said opposed heating clamp members being supported on a separate one of said support columns for movement toward one another to said closed state and away from one another to said open state, and each of said opposed cooling clamp members being supported on a separate one of said support columns for movement toward one another to said closed state and away from one another to said open state.

4. The tool of claim 3, wherein said at least one clamp assembly includes a plurality of clamp assemblies spaced in mirrored, axially aligned relation with one another such that said channels are aligned with one another for simultaneous receipt of the textile sleeve therein.

5. The tool of claim 1, wherein said opposed heating and cooling clamp members are supported by upstanding support columns spaced from one another by a slide channel sized for clearance receipt of the textile sleeve therein, each of said opposed heating clamp members being supported on a separate one of said support columns for movement toward one another to said closed state and away from one another to said open state, and each of said opposed cooling clamp members being supported on a separate one of said support columns for movement toward one another to said closed state and away from one another to said open state.

6. The tool of claim 1, wherein said first axis is substantially parallel with said second axis.

7. The tool of claim 6, wherein said third axis is substantially transverse with said first axis and said second axis.

8. The tool of claim 7, wherein said carrier includes a pair of opposed clamp members movable along a fourth axis between an open state, whereat the textile sleeve can be loaded between and unloaded from between the clamp members, and a closed state, whereat the textile sleeve clamped between the clamp members.

9. The tool of claim 8, wherein said fourth axis is substantially parallel with said first axis and said second axis.

10. A method of fixing a textile sleeve about an elongate member, comprising:
disposing the elongate member within an internal cavity of the textile sleeve;
clamping a first portion of the textile sleeve about the elongate member with heating clamp members and forming a bond joint between separate portions of the textile sleeve and/or between the textile sleeve and the elongate member by heating the first portion of the textile sleeve with the heating clamp members; and
clamping the first portion of the textile sleeve about the elongate member with cooling clamp members having clamp surfaces formed by cooling members and cooling the bond joint with the cooling clamp members.

11. The method of claim 10, further including clamping a second portion of the textile sleeve about the elongate member spaced axially from the first portion with heating clamp members and forming a bond joint between separate portions of the textile sleeve and/or between the textile sleeve and the elongate member by heating the second portion of the textile sleeve with the heating clamp members;
clamping the second portion of the textile sleeve about the elongate member with cooling clamp members having clamp surfaces formed by cooling members and cooling the bond joint with the cooling clamp members.

12. The method of claim 11, further including performing the clamping of the first and second portions simultaneously with one another.

13. The method of claim 10, further including moving the textile sleeve with elongate member therein from the heating clamp members to the cooling clamp members within 1-5 seconds after forming the bond joint.

14. The method of claim 13, further including heating the first portion of the textile sleeve with the heating clamp members for about 4-10 seconds.

15. The method of claim 14, further including heating the first portion of the textile sleeve with the heating clamp members at a temperature between about 190-230 degrees.

16. The method of claim 14, further including cooling the bond joint for about 1-6 seconds.

17. The method of claim 16, further including cooling the first portion of the textile sleeve with the cooling clamp members at a temperature between about 60-80 degrees.

18. The method of claim 10, further including moving the heating clamp members along a first axis to clamp and release the textile sleeve, moving the cooling clamp members along a second axis to clamp and release the textile sleeve, and moving the textile sleeve along a third axis between the heating clamp members and the cooling clamp members, and orienting the first axis in substantially parallel relation with the second axis.

19. The method of claim 18, further including orienting the third axis in substantially transverse relation with the first and second axes.
